(19) United States
(12) Patent Application Publication
(10) Pub. No.: US 2012/0294159 A1
(43) Pub. Date: Nov. 22, 2012

(54) METHOD OF MEASURING ACTIVITY OVER A VOIP CALL

(75) Inventor: Sriram Sridhar, Lowell, MA (US)

(73) Assignee: GENERAL INSTRUMENT CORPORATION, Horsham, PA (US)

(21) Appl. No.: 13/109,142

(22) Filed: May 17, 2011

(51) Int. Cl. H04L 12/66; H04L 12/26

(52) U.S. Cl. 370/252

(57) ABSTRACT

A method (250) of measuring activity over a VOIP call is disclosed. The method (250) includes: detecting (260) whether a voice over internet protocol call includes a comfort noise payload format; and counting (270) the number of comfort noise packets transmitted during a voice over internet protocol call. Advantageously, this can provide usage information, quality of transmission information, billing information and other useful information.

### BACKGROUND

1. Field

The present disclosure relates to a method of measuring activity over a voice over Internet protocol (VOIP) call.

2. Introduction

Due to the advancement in high speed bandwidth transmission to home users, many cable operators and Passive Optical Network operators have chosen to provide Triple Play services (Voice, Video and Data services) over an IP backbone. For example, Verizon provides Triple Play services to its Gigabit Passive Optical Network (GPON) customers and uses Voice Over Internet Protocol (VOIP or Voice Over IP), Session Initiation Protocol (SIP) and Real Time Protocol (RTP) for voice services. Based on an end user needs, various types of Optical Network Terminals (ONT) are chosen. To help the reader, there is a table of commonly used acronyms below.

SIP is used as a signaling protocol between Optical Network Terminals (ONTs) via the Optical Line Terminals (OLTs) and the endpoints are connected to the ports available in the Optical Network Terminals.

Operators, such as Verizon, have deployed Fiber Optic network to its end customers. It uses Voice over Internet Protocol for voice communication via Optical Network terminals (ONT's) and Optical Line terminals (OLT's).

Session Initiation Protocol (SIP) is used for signaling between the ONT's. RTP/RTCP

There are a number of issues faced in GPON networks. There are many User Agent Servers in a GPON network which act as Back-to-Back User Agents for both Signaling and Media packets. This means that they route User Data Protocol (UDP) SIP packets used for signaling and RTP (Media) packets used to transmit a voice payload encoded using a codec. A typical network topology for end-to-end voice packet traversal would look like the below:

### ONT< - - - >OLT< - - - >SBC< - - - >VOICE Switch< - - - >SBC< - - - >OLT< - - - >ONT

In summary, when RTP packets traverse through these network devices, they are monitored for jitter latency. SBC is a Session Border Controller and a Voice Switch (VS) stores and routes calls based on the endpoint identification and privileges. Conventional Voice Switches can include a CS2K or a BroadSoft Switch.

A group called the International Telecommunication Union (ITU-T) defines a comfort noise payload format for transporting comfort noise when the Voice Activity Detection (VAD) is enabled on POTS lines. This is done to detect the absence of audio and conserve bandwidth by preventing the transmission of “silent packets” over the network. This comfort noise payload format is dependent on the codec that is used for encoding and decoding the voice payload. For example, Codecs G.711, G.726, G.727, G.728, and G.722 follow RFC 3889 for transporting comfort noise. The Optical Network Terminal (ONT) devices generate and consume the RTP packets parse this payload but do not inform a Billing or Monitoring Server about the number of (Silence Insertion Descriptor) SID packets transmitted or received in the network during an active voice call. Presently, G729 packets do not have a payload descriptor and this comfort noise information is embedded in the voice payload itself.

It would be considered an improvement in the art, if there were a method for monitoring, counting and/or reporting SID packets. For example, billing and call monitoring servers could gain improved insight and a better understanding of the actual duration of a call, whether both subscribers involved in the call were actively talking, and could provide an enhanced estimate of the number of RTP packets sent and received during a call. This could also inform the network service provider, that a “Voice Activity Detection” module is operational, as this is a feature which is typically controlled by the network service provider for each Optical Line Terminal (OLT) available in a network.

Thus, a method that addresses these issues and problems would be considered an improvement in the art.

Table of Acronyms:

| | |
|---|---|
| Codec | Program that is capable of encoding/decoding a digital |
| | media stream |
| FTTP | Fiber To The Premises |
| GPON | Gigabit Passive Optical Network |
| ITU-T | International Telecommunication Union |
| Jitter | A measure of Average variation from the Network Mean |
| | Latency |
| Latency | It is a measure of time delay experienced in a System |
| OLT | Optical Line Terminal |
| ONT | Optical Network Terminal |
| POTS | Plain Old Telephony Service |
| RTP | Real Time Protocol |
| RTTP | Real-time Transport Protocol |
| RTCP | Real-time Transport Control Protocol |
| RTCP SR | RTCP Sender Reports |
| RTCP RR | RTCP Receiver Reports |
| SBC | Session Border Controller |
| SDP | Session Description Protocol is a format for describing |
| | multimedia streams |
| SID | Silence Insertion Descriptor |
| SIP | Session Initiation Protocol |
| SIP UA | SIP User Agent |
| Voice | Switch that controls VOIP call routing and management, |
| Switch | such as a CS2K or Broadsoft Switch |

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is an exemplary block diagram of a communication system according to one embodiment.

FIG. 2 is an exemplary block diagram of a method of measuring activity over a voice over internet protocol call, according to one embodiment.

FIG. 3 is an exemplary ladder diagram of a method of measuring activity over a voice over internet protocol call, according to one embodiment.

### DETAILED DESCRIPTION

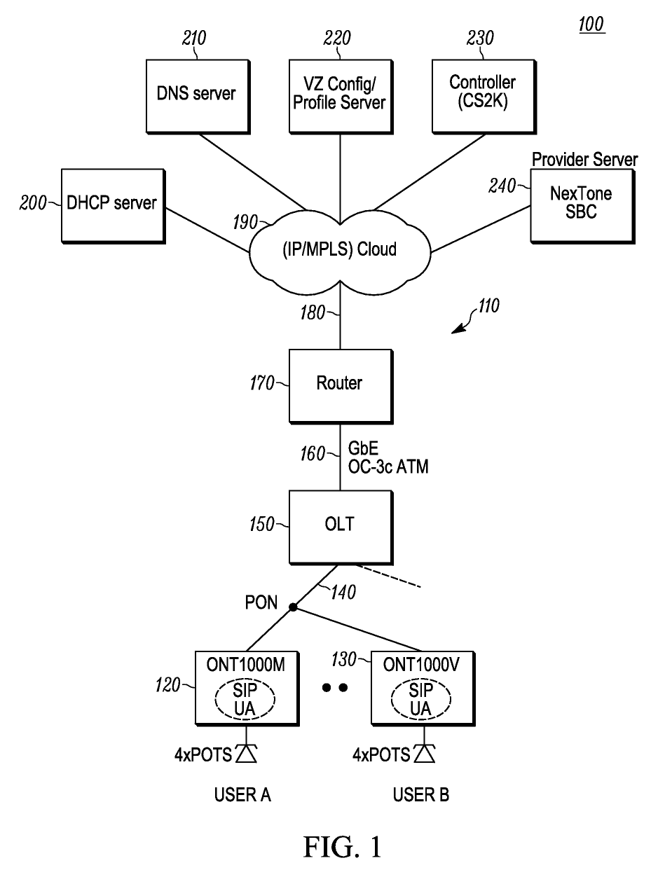

FIG. 1 is an exemplary block diagram of a system 100 according to one embodiment. The system 100 can include a network 110, a session initiation protocol user agent (SIP UA) terminals 120 and 130, shown as User A and User B, Passive Optical Network (PON) line 140. The line 140 is connected to an OLT 150. The network includes a PON line 160 connecting OLT 150 and router 170. PON line 180 connects the router 170 with a cloud 190, such as an IP/MPLS cloud. The cloud 190 can be connected to and include a plurality of servers, such as a Dynamic Host Configuration Protocol (DHCP) Server 200, a Dynamic Name System (DNS) Server 210, Profile Server 220, Controller 230, such as a Nortel CS2K switch, and Provider Server 240. As should be understood, various servers, routers, switches, controllers, network equipment and the like, can be used as desired.

For example, in one embodiment, the Controller 230 can be a switch which does call control signaling and routing such as a Nortel CS2K switch, and the Provider Server 240 can be a NexTone server. The network 110 may be hardwired, a wireless telecommunications network or a hybrid of both, and can include a cellular telephone network, a Time Division Multiple Access (TDMA) network, a Code Division Multiple Access (CDMA) network, Global System for Mobile Communications (GSM), a Third Generation (3G) network, a Fourth Generation (4G) network, a satellite communications network, and other like communications systems. More generally, network 110 may include a Wide Area Network (WAN), a Local Area Network (LAN) and/or a Personal Area Network (PAN). Furthermore, the network 110 may include more than one network and may include a plurality of different types of networks. Thus, the network 110 may include a plurality of data networks, a plurality of telecommunications networks, a combination of data and telecommunications networks and other like communication systems capable of sending and receiving communication signals. In operation, the terminals 120 and 130 can communicate with the network 110 and with other devices on the network 110 by sending and receiving wireless signals, via line 140, which may also comprise local area, and/or personal area access points.

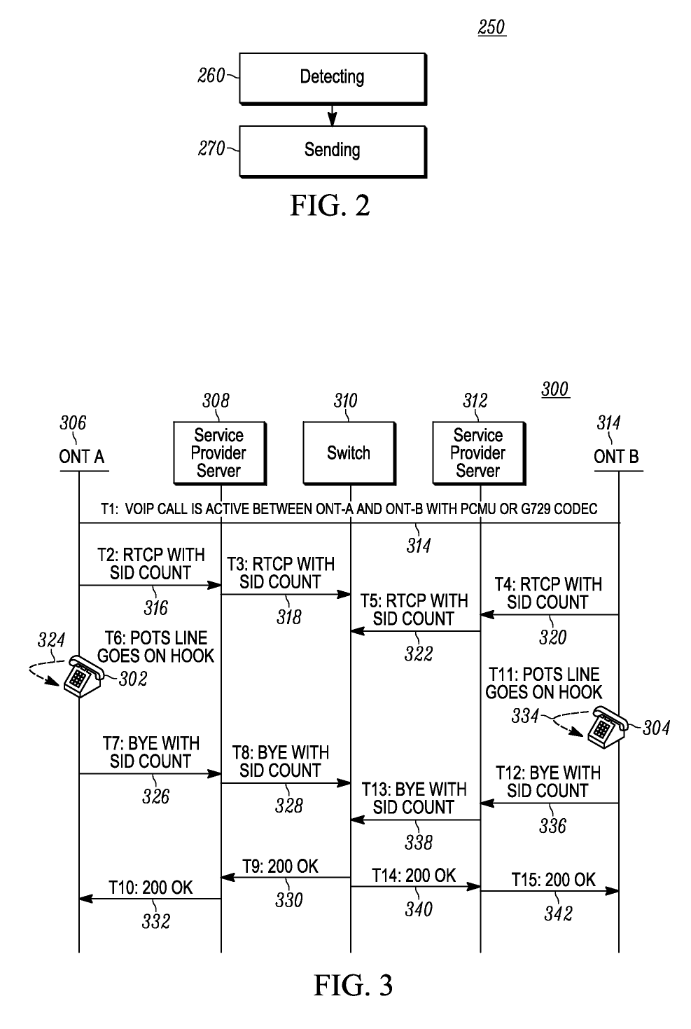

FIG. 2 is an exemplary block diagram of a method of measuring activity over a VOIP call. The method 250 includes: detecting 260 whether a voice over internet protocol call includes a comfort noise payload format; and counting 270 the number of comfort noise packets transmitted during a voice over internet protocol call.

Advantageously, this can provide usage information, quality of transmission information, billing information and other useful information to a service provider, for example. In one embodiment, the method can contribute to providing a straight forward approach to provide information on the SID count, to a switch 310 to update the call records. This provides value add information to a network operator, because it can provide more information on the RTP packet count and statistics. It can also provide information to a network operator, for verifying that a VAD (Voice Activity Detection) feature is working on the Optical Network Terminals. This can also help to provide and promote efficient bandwidth consumption methods in voice traffic, as detailed below.

In one embodiment, the method 250 further includes establishing a voice over internet protocol call between a sender and a receiver, the sender and receiver comprise optical line terminals. This could occur before the detecting step 270.

In a preferred embodiment, the comfort noise payload format includes a comfort noise flag. The comfort noise flag can be set at one if the comfort noise payload is present in a RTP packet and if comfort level fields contain reports and a zero if not. This feature can be easily deployable and implemented to be compatible with the International Telecommunication Union (ITU-T) comfort noise payload format for transporting comfort noise when the Voice Activity Detection (VAD) is enabled on POTS lines.

The method 250 can further include providing a report including a silence insertion descriptor (SID) count transmitted during a call or particular sequence number interval. Further, the report can be sent in RTCP format. Advantageously, these features can help to provide: a service provider with enhanced call tracking activity information and usage information in more detail; and (ii) more detailed information for clarity in billing and quality of service analysis. In one embodiment, the report can be compatible with the RFC3611 standard, which defines a method for extended reporting format to convey information that supplements six statistics that are contained in the report blocks used by RTCP's Sender Report (SR) and Receiver Report (RR) packets.

In one case, the method 250 is compatible and in compliance with the RFC 3389 standard. The RFC 3389 defines a comfort noise payload and consists of a single octet description of the noise level and may contain spectral information in subsequent octets.

In one embodiment, a Statistics Summary Report can be provided by adding one more statistic named as “comfort noise packet count”. This specifies the number of comfort noise packets transmitted during that sequence number interval.

An example, is provided below:

1. A comfort noise flag (C) is provided with one bit. It is to one if the comfort noise payload is present in the RTP packet and if comfort noise fields all contain reports. And, it is set at zero, if none of them do.

2. The SID count is provided with 32 bits. This specifies the number of comfort noise packets transmitted during that sequence number interval.

As should be understood, the number of bits, bit values and the below layout can be changed, without departing from the spirit of the invention.

### Exemplary Statistics Summary Report Block Sent in RTCP:

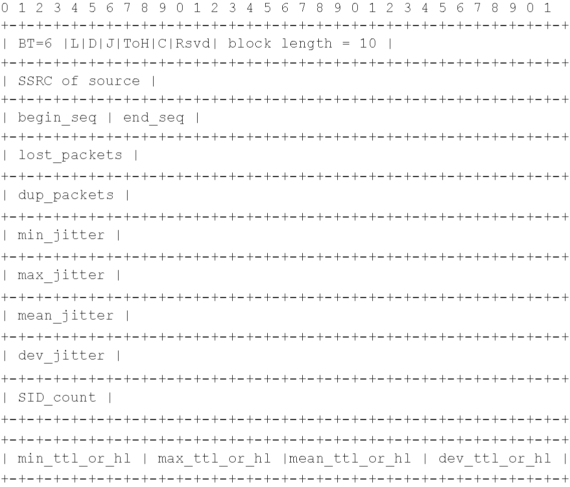

A new Session Description Protocol (SDP) attribute can be added to the SDP attribute “rtcp-xr” that is currently used in RFC 3389, to signal participants in a media session that they should use the specified XR blocks.

The RTCP XR blocks SDP attribute is defined below in Augmented Backus-Naur Form.

rtcp-xr-attrib = ″a=″ ″rtcp-xr″ ″:″ [xr-format *(SP xr-format)] CRLF
xr-format = sid-count
sid-count = “sid-count” [“=” max-size]

When a call is disconnected, the total number of sid-count information can be passed in the SDP information in a BYE message.

Turning now to FIG. 3, an exemplary process flow and exemplary ladder diagram 300 is shown. POTS A (Sender A) is shown as 302 and POTS B (Receiver B) is shown as 314. FIG. 3 provides ONT A as 306, Service Provider Server (SPS) 308, Switch 310, Service Provider Server (SPS) 312 and ONT B 314.

At T1 314 a SIP VOIP call is established between ONT-A 306 and ONT-B 314 with a Codec pass through. Both endpoints are using RTP protocol to exchange payload data.

At T2 316, as per the RTP/RTCP standards, both the endpoints ONT-A 306 and ONT-B 314 exchange RTCP reports between each other, which includes information about the quality of the ongoing voice call. A silence insertion descriptor (SID) count, as a part of this RTCP protocol is included, to inform the Switch 310 about the silence packets inserted during the call. The Switch 310 can include an actual switch which does the call control signaling, such as a CS2K or broadsoft switch.

At T3 318, the RTCP packet is forwarded by SPS 308 to the actual voice switch 310.

At T4 320, the endpoints begin to exchange RTCP reports between each other which provides information about the quality of the ongoing voice call. More specifically, a SID count is included as a part of this RTCP protocol to inform the switch 310 about the number of SID packets inserted during the call.

At T5 322, the RTCP packet is forwarded by SPS 312 to the switch 310.

It is worth noting, that the T2 and T3 sequence and the T4 and T5 sequence can occur independent of each other. This information can be periodically transmitted to the switch 310 at pre-defined intervals for the entire duration of the VOIP call.

At T6 324, a POTs line connected to ONT A 306 goes on-hook which is an indicator that the voice call is disconnected.

At T7 326, a BYE message is sent out with a total SID packet count for the entire call duration.

At T8 328, the SPS 308 forwards this bye message to the actual switch 310.

At T9 330, the switch 310 sends an acknowledgement to the SPS 308 that it has successfully received the BYE message.

At T10 332, the SPS 308 forwards this information back to the pots line connected to the ONT A 306.

At T11 334, the POTS line connected to ONT B goes on-hook, which is an indication that the voice call is disconnected.

At T12 336, again as per the SIP standards, a BYE message is sent out with a total SID packet count for the entire call duration.

At T13 338, the SPS 312 forwards this BYE message to the switch 310.

At T14 342, the switch 310 sends an acknowledgement to the SPS 312 that it successfully received the BYE message.

And, at T15 342, the SPS 312 forwards this information back to the pots line connected to ONT B 314. ont-b.

It is noted that the sequence from T6 to T10 are independent of the sequence from T11 to T14 and occur when an active call is disconnected or when the POTs lines go on hook.

### EXAMPLE

Detailed herein is a example of the messages sent.

BYE sip:19782078459@192.172.112.24;transport=UDP;user=phone
SIP/2.0
From: <sip:19788092702@192.172.100.125;user=phone>;tag=812178a8-
c0ac731e-13c4-40030-117b0-7955caaa-117b0
To: <sip:19782078459@192.172.100.100;user=phone>;tag=8705bc98-
c0ac7018-13c4-40030-20c4-222f0c8b-20c4
Call-ID: 81213e98-29983-1264771243-14320079-00302d4182e3-
1@192.172.115.30
CSeq: 2 BYE
Via: SIP/2.0/UDP 192.172.115.30:5060;branch=z9hG4bK-117ce-444ff62-
77e6a667
User-Agent: Motorola ONT1400GT SN-MRCC00056FC9 SW-7.2.0 LN-1
Max-Forwards: 70
Supported: replaces, timer
Route: <sip:19782078459@192.172.100.100;lr=on;ftag=812178a8-
c0ac731e-13c4-40030-117b0-7955caaa-117b0>
Content-Length: 134
v=0
o=19788092702 3473759572 3473759572 IN IP4 192.172.115.30
s=SIP Call
c=IN IP4 192.172.115.30
t=0 0
a= rtcp-xr: sid-count=50

When a call is disconnected, the Optical Network Terminals send a BYE message towards the switch 310. In a preferred embodiment, the BYE message carries SID count information. This information would be helpful for the switch 310 to update the call records and count or know exactly how many SID frames were sent during the call.

The methods shown in FIGS. 2 and 3, provide a straight forward approach to provide information on the SID count, to a switch 310 to update the call records. This provides value add information to a network operator, because it can provide more information on the RTP packet count and statistics. It can also provide information to a network operator, for verifying that a VAD (Voice Activity Detection) feature is working on the Optical Network Terminals. This can also help to provide and promote efficient bandwidth consumption methods in voice traffic.

The method 250 is preferably implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

We claim:

1. A method of measuring activity over a voice over internet protocol call, comprising:
detecting whether a voice over internet protocol call includes a comfort noise payload format; and
counting the number of comfort noise packets transmitted during a voice over internet protocol call.

2. The method of claim 1, wherein the comfort noise payload format includes a comfort noise flag.

3. The method of claim 1, wherein the comfort noise payload format includes a comfort noise flag including being set at one if the comfort noise payload is present in a RTP packet and if comfort level fields contain reports and a zero if not.

4. The method of claim 1, further comprising providing a report including a silence insertion descriptor count.

5. The method of claim 1, further comprising passing a silence insertion descriptor count in a bye message.

6. The method of claim 1, further comprising providing a report including a silence insertion descriptor count and sending it in RTCP.

7. The method claim 1 further comprising establishing a voice over internet protocol call between a sender and a receiver, the sender and receiver comprise optical line terminals.

8. The method of claim 1 wherein the method is in substantial compliance with a RFC3389 standard.

9. The method of claim 1 wherein the method is in substantial compliance with a RFC3611 standard.

10. A method of measuring activity over a voice over internet protocol call, comprising:
establishing a voice over internet protocol call between a sender and a receiver, the sender and receiver comprise optical line terminals.
detecting whether a voice over internet protocol call includes a comfort noise payload format; and
counting the number of comfort noise packets transmitted during a voice over internet protocol call.

11. The method of claim 10, wherein the comfort noise payload format includes a comfort noise flag.

12. The method of claim 10, wherein the comfort noise payload format includes a comfort noise flag including being set at one if the comfort noise payload is present in a RTP packet and if comfort level fields contain reports and a zero if not.

13. The method of claim 10, further comprising providing a report including a silence insertion descriptor count.

14. The method of claim 10, further comprising passing a silence insertion descriptor count in a bye message.

15. The method of claim 10, further comprising providing a report including a silence insertion descriptor count and sending it in RTCP.

16. The method of claim 10 wherein the method is in substantial compliance with at least one of a RFC3389 standard and a RFC3611 standard.
